(19) United States
(12) Patent Application Publication
(10) Pub. No.: US 2021/0016304 A1
(43) Pub. Date: Jan. 21, 2021

(54) FLOW SWITCH FOR HAND SHOWERS

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN)

(73) Assignee: Purity (Xiamen) Sanitary Ware Co., Ltd., Xiamen City, Fujian (CN)

(21) Appl. No.: 16/516,444

(22) Filed: Jul. 19, 2019

(51) Int. Cl. B05B 1/30; B05B 1/18; B05B 1/16

(52) U.S. Cl. CPC B05B 1/30; B05B 1/16; B05B 1/18

(57) ABSTRACT

The present disclosure provides a flow switch for a hand shower, including an inlet assembly connected to an inlet end of a switching assembly and an outlet assembly connected to an outlet end of the switching assembly. The switching assembly includes a diverter member, a gearing member, a first switching assembly and a second switching assembly. The diverter member has a first installing groove and a second installing groove, wherein each of the first installing groove and the second installing groove has one inlet opening and two outlet openings. The first switching assembly is operated to open or close the two outlet openings of the first installing groove. The second switching assembly is operated to open or close the two outlet openings of the second installing groove. The gearing member could drive the first switching assembly and the second switching assembly to be continuously operated with each other.

### BACKGROUND OF THE INVENTION

### 1. Technical Field

The present disclosure relates generally to a hand shower, and more particularly to a flow switch for the hand shower.

### 2. Description of Related Art

There are many ways to spray water in kitchen, such as shower water, sparkling water, and/or blade water. The showers of current devices are basically operated by a single button to switch two water outlet modes. With the advancement of society and the improvement of living standards, users have more and more functional requirements for showers. The showers having two water outlet modes have been difficult to meet the needs of users. To achieve more water outlet modes, it depends on installing more flow ways, which leads to increase more buttons to switch the flow ways. However, it makes the product structure being complex and bulky, and would increase the cost of production.

At least for the above reasons, the conventional switch still have room for improvements.

### BRIEF SUMMARY OF THE INVENTION

In view of the above, the primary objective of the present disclosure is to provide a flow switch for a hand shower which could switch three independent outlet modes, in order to provide products having smaller structure, whereby to reduce a volume of the products, and to decrease the cost of production.

The present disclosure provides a flow switch for a hand shower. The flow switch for a hand shower includes an inlet assembly, a switching assembly and an outlet assembly. The inlet assembly is installed at an inlet end of the switching assembly while the outlet assembly is installed at an outlet end of the switching assembly. The switching assembly includes a diverter member, a gearing member, a first switching assembly and a second switching assembly. The diverter member has a first installing groove and a second installing groove recessed from a surface of the diverter member. An extended direction of the first installing groove is parallel to an extended direction of the second installing groove, and the opening of the first installing groove face the opening of the second installing groove. The first switching assembly correspondingly fits into the first installing groove, and the second switching assembly correspondingly fits into the second installing groove. Said diverter member has a first inlet channel positioned at the inlet end of the diverter member, and has a first outlet channel, a second outlet channel and a third outlet channel positioned at the outlet end of the diverter member. Said first installing groove has a first inlet opening communicating with the first inlet channel, and a first outlet opening and a second outlet opening communicating with the first outlet channel. The first outlet opening, the first inlet opening and the second outlet opening are sequentially arranged on an inner wall of the first installing groove in an axial direction of the first installing groove. The second outlet opening is positioned at a bottom of the first installing groove. Said second installing groove has a second inlet opening communicating with the second outlet opening, a third outlet opening communicating with the second outlet channel and a fourth outlet opening communicating with the third outlet channel. The third outlet opening, the second inlet opening and the fourth outlet opening are sequentially arranged on an inner wall of the second installing groove in an axial direction of the second installing groove. The fourth outlet opening is positioned at a bottom of the second installing groove. Said gearing member has a mad-section hinged to the diverter member and positioned at the openings of the first installing groove and the second installing groove.

Said first switching assembly includes a first fixing member, a first linking rod and a sealing member. The first fixing member is correspondingly positioned to seal between the hole of the first installing groove and the first inlet opening, and to block the first outlet opening. The first fixing member has a first movable chamber, and a hole of the first movable chamber faces the second outlet opening; the first movable chamber has a fifth outlet opening communicating with the first outlet opening. The first movable chamber has a first perforation positioned in the axial direction of the first installing groove. The first linking rod movably fits to seal the first perforation. One end of the first linking rod is hinged to one end of the gearing member. A first return spring is positioned between one end of the gearing member and the first fixing member. The sealing member has a second movable chamber. The first linking rod has a blocking flange positioned at another end of the first linking rod. A restrain member is fixed at a hole of the second movable chamber. The first linking rod movably passes through the restrain member. The another end of the first linking rod is movably corresponding to the second movable chamber, and the blocking flange is movably corresponding to the restrain member. A second return spring is positioned between the first movable chamber and the sealing member, and the sealing member movably fits to seal the hole of the first movable chamber or the second outlet opening. Said second movable chamber has a height greater than or equal to a gap between the first inlet opening and the second outlet opening in the axial direction of the first installing groove.

Said second switching assembly includes a second fixing member and a second linking rod. The second fixing member is correspondingly positioned to seal between the hole of the second installing groove and the second inlet opening, and to block the third outlet opening. The second fixing member has a third movable chamber, and a hole of the third movable chamber faces the fourth outlet opening. The third movable chamber has a sixth outlet opening communicating with the third outlet opening. The third movable chamber has a second perforation positioned in the axial direction of the second installing groove. One end of the second linking rod movably fits to seal the second perforation, and movably abuts against another end of the gearing member. The second linking rod has a first sealing portion positioned at another end of the second linking rod and movably fitting to seal a hole of the third movable chamber or the fourth outlet opening. A third return spring is positioned between the first sealing portion and the bottom of the second installing groove.

According to embodiments of the present disclosure, a first sealing ring is sleeved around said sealing member, and movably fits to seal the hole of the first movable chamber or the second outlet opening.

According to embodiments of the present disclosure, a second sealing ring is sleeved around said first sealing rod, and movably fits to seal the hole of the first perforation.

According to embodiments of the present disclosure, a first sealing loop is sleeved around said first fixing member, and movably fits to seal between the first fixing member and the first installing groove.

According to embodiments of the present disclosure, a supporting member is positioned on said fourth outlet opening, and the supporting member has a first fixing rod protruded from a mid-section of the supporting member toward the first sealing portion. The first sealing portion has a second installing chamber corresponding to the first fixing rod. The first fixing rod passes through the second installing chamber, and the third return spring is positioned between a bottom of the second installing chamber and a top of the first fixing rod.

According to embodiments of the present disclosure, a third sealing ring is sleeved around said first sealing portion, and movably fits to seal the hole of the third movable chamber or the fourth outlet opening.

According to embodiments of the present disclosure, a fourth sealing ring is sleeved around a mid-section of said second linking rod, and movably fits to seal between the second perforation and the sixth outlet opening.

According to embodiments of the present disclosure, a second sealing loop is sleeved around said second fixing member, and movably fits to seal between the second fixing member and the second installing groove.

According to embodiments of the present disclosure, said inlet assembly includes an inlet member and a third switching assembly. Said inlet member has a third installing groove recessed from a surface of the inlet member. The third switching assembly correspondingly fits in the third installing groove. The inlet member has a second inlet channel at an inlet end of the inlet member, and the second inlet channel is adapted to connect to a pipe. The inlet member has a fourth outlet channel at an outlet end of the inlet member, and the fourth outlet channel communicates with the first inlet channel. Said third installing groove has a third inlet opening communicating with the second inlet channel, and a seventh outlet opening communicating with the fourth outlet channel. The seventh outlet opening is positioned at a bottom of the third installing groove. Said third switching assembly movably fits to seal the seventh outlet opening.

According to embodiments of the present disclosure, said third switching assembly includes a third fixing member and a third linking rod. The third fixing rod correspondingly fits to seal between a hole of the third installing groove and the third inlet opening. The third fixing member has a third perforation positioned in an axial direction of the third installing groove. The third linking rod movably fits to seal the third perforation. One end of the third linking rod passes through the inlet member while the third linking rod has a second sealing portion positioned at another end of the third linking rod. A fourth return spring is positioned between the second sealing portion and the bottom of the third installing groove. A restrain flange is positioned at the third perforation, and is corresponding to the second sealing portion. The second sealing portion movably fits to seal the restrain flange or the seventh outlet opening.

According to embodiments of the present disclosure, said seventh outlet opening has a second fixing rod positioned at a bottom of the seventh outlet opening. The second sealing portion has a third installing chamber corresponding to the second fixing rod. The second fixing rod passes through the third installing chamber, and a fourth return spring is positioned between a bottom of the third installing chamber and a top of the second fixing rod.

According to embodiments of the present disclosure, a fifth sealing ring is sleeved around said second sealing portion, and movably fits to seal the seventh outlet opening.

According to embodiments of the present disclosure, a sixth sealing ring is sleeved around a mid-section of said third linking rod, and movably fits to seal between the third perforation and the third inlet opening.

According to embodiments of the present disclosure, a third sealing loop is sleeved around said third fixing member, and movably fits to seal between the third fixing member and the third installing groove.

According to embodiments of the present disclosure, a second button is connected to one end of said third linking rod.

According to embodiments of the present disclosure, said outlet assembly includes a first outlet chamber, a second outlet chamber and a third outlet chamber respectively corresponding to the first outlet channel, the second outlet channel and the third outlet channel. The first outlet channel communicates with the first outlet chamber, the second outlet channel communicates with the second outlet chamber, and the third outlet channel communicates with the third outlet chamber. An outlet mode of the first outlet chamber, an outlet mode of the second outlet chamber and an outlet mode of the third outlet chamber are different from each other.

According to embodiments of the present disclosure, the flow switch for a hand shower further includes a housing of the hand shower. The housing of the hand shower includes a first installing chamber, and the inlet assembly, the switching assembly and the outlet assembly are sequentially connected to each other and are installed in the first installing chamber.

According to embodiments of the present disclosure, said diverter member has a passing through chamber, and the second outlet opening and the second inlet opening respectively communicate with the passing through chamber.

According to embodiments of the present disclosure, a first button is fixed on said gearing member, in order to be operated conveniently.

Through the mentioned structure, the first switching assembly could control the two outlet openings of the first installing groove while the second switching assembly could control the two outlet openings of the second installing groove, and the gearing member is positioned to drive the both to be continuously operated with each other, whereby to switch three outlet modes in the present disclosure, so as to provide products having compact structure, so as to reduce a volume of the products, and to decrease the cost of production. Further, one end of the first linking rod could be moved in the second movable chamber positioned in the sealing member, so that the second outlet opening could keep being opened during switching, whereby to continuously outlet from the second outlet opening, in order to inlet into the second installing groove, and to outlet from the second outlet channel and the third outlet channel.

In addition, for the third switching assembly is positioned in the inlet assembly, a pause inlet function could be provided, which is convenient to move a hand shower in use, and could prevent water from sprinkling.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a perspective view of one embodiment of the present disclosure;

FIG. 2 is a partial exploded view of one embodiment of the present disclosure;

FIG. 3 is an exploded view of a switching assembly of one embodiment of the present disclosure;

FIG. 4 is a front view of a diverter member of one embodiment of the present disclosure;

FIG. 5 is a rear view of the diverter member of one embodiment of the present disclosure;

FIG. 6 is a cross-sectional view of FIG. 4 taken along with A-A line;

FIG. 7 is a cross-sectional view of FIG. 4 taken along with B-B line;

FIG. 8 is a schematic view of the switching assembly of one embodiment of the present disclosure, wherein the switching assembly is in a first outlet mode (an initiation state);

FIG. 9 is a schematic view of the switching assembly of one embodiment of the present disclosure, wherein the switching assembly is switched to a second outlet mode;

FIG. 10 is a schematic view of the switching assembly of one embodiment of the present disclosure, wherein the switching assembly is switched to a third outlet mode;

FIG. 11 is a schematic view of the switching assembly of one embodiment of the present disclosure, wherein the switching assembly is switched to the first outlet mode;

FIG. 12 is an exploded view of an inlet assembly of one embodiment of the present disclosure;

FIG. 13 is a schematic view of the inlet assembly of one embodiment of the present disclosure, which shows water flow conditions of the inlet assembly;

FIG. 14 is a perspective view of the inlet assembly of one embodiment of the present disclosure.

### DETAILED DESCRIPTION OF THE INVENTION

In order to illustrate the present disclosure more clearly, the preferred embodiments and the accompanying drawings are described in detail below.

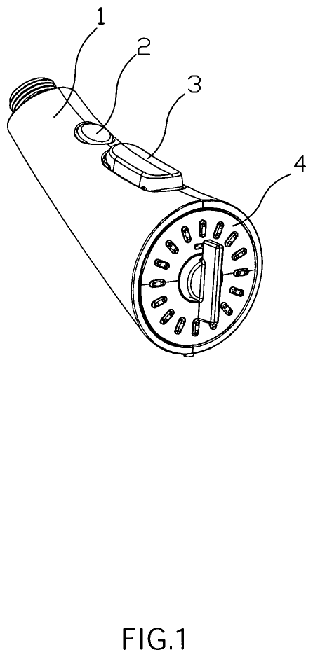

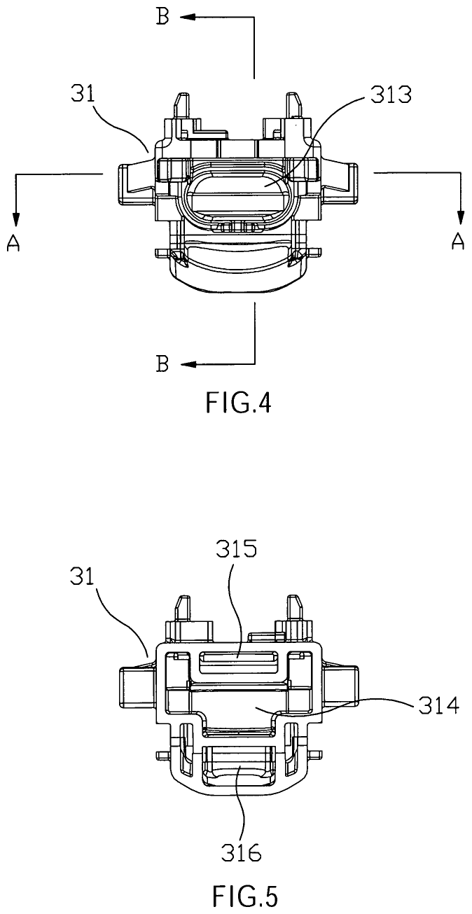

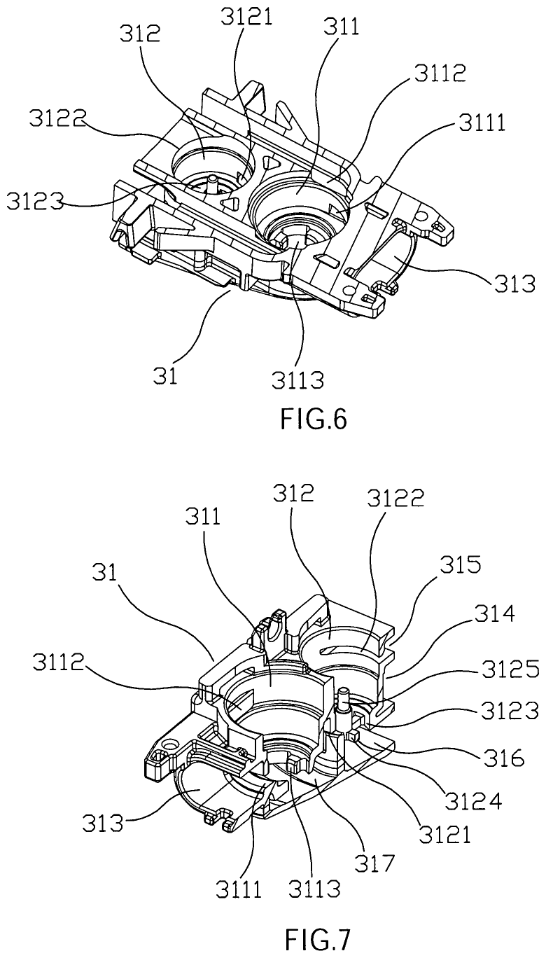

As illustrated in FIG. 1 to FIG. 14, in one preferred embodiment of the present disclosure, a flow switch for a hand shower includes a housing 1 of the hand shower, an inlet assembly 2, a switching assembly 3 and an outlet assembly 4. The inlet assembly 2, the switching assembly 3 and the outlet assembly 4 are installed in the housing 1. The inlet assembly 2 is installed at an inlet end of the switching assembly 3 while the outlet assembly 4 is installed at an outlet end of the switching assembly 3.

In embodiments of the present disclosure, three outlet modes could be switched through operating the switching assembly 3 to control the three outlet modes of three flow ways in the flow switch, and could be provided by the outlet assembly 4. The inlet assembly 2 is used to temporarily block the water flow.

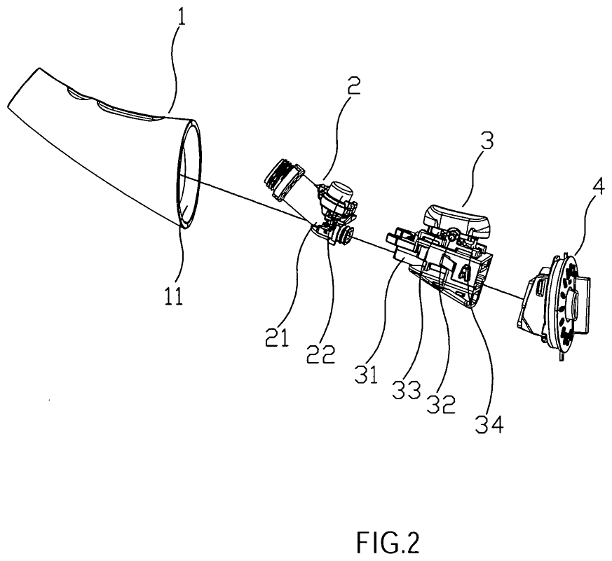

As shown in FIG. 2, said housing 1 of the hand shower includes a first installing chamber 11, and the inlet assembly 2, the switching assembly 3 and the outlet assembly 4 are sequentially connected to each other and are installed in the first installing chamber 11.

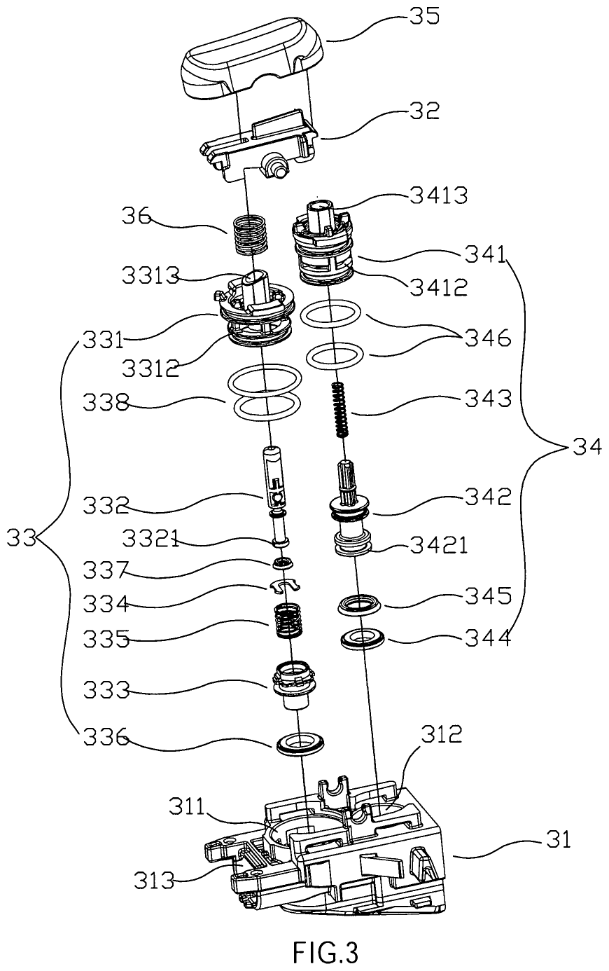

As shown in FIG. 3 to FIG. 7, said switching assembly 3 includes a diverter member 31, a gearing member 32, a first switching assembly 33 and a second switching assembly 34. The diverter member 31 has a first installing groove 311 and a second installing groove 312 recessed from a surface of the diverter member 31. An extended direction of the first installing groove 311 is parallel to an extended direction of the second installing groove 312, and the opening of the first installing groove 311 face the opening of the second installing groove 312. The first switching assembly 33 correspondingly fits into the first installing groove 311, and the second switching assembly 34 correspondingly fits into the second installing groove 312. Said diverter member 31 has a first inlet channel 313 positioned at the inlet end of the diverter member 31, and has a first outlet channel 314, a second outlet channel 315 and a third outlet channel 316 positioned at the outlet end of the diverter member 31. Said first installing groove 311 has a first inlet opening 3111, a first outlet opening 3112 and a second outlet opening 3113. The first outlet opening 3112, the first inlet opening 3111 and the second outlet opening 3113 are sequentially arranged on an inner wall of the first installing groove 311 in an axial direction of the first installing groove 311. The second outlet opening 3113 is positioned at a bottom of the first installing groove 311. The first inlet opening 3111 communicates with the first inlet channel 313, and the first outlet opening 3112 communicates with the first outlet channel 314. Said second installing groove 312 has a second inlet opening 3121, a third outlet opening 3122 and a fourth outlet opening 3123. The third outlet opening 3122, the second inlet opening 3121 and the fourth outlet opening 3123 are sequentially arranged on an inner wall of the second installing groove 312 in an axial direction of the second installing groove 312. The fourth outlet opening 3123 is positioned at a bottom of the second installing groove 312. The second inlet opening 3121 communicates with the second outlet opening 3113, the third outlet opening 3122 communicates with the second outlet channel 315, and the fourth outlet opening 3123 communicates with the third outlet channel 316. According to embodiments of the present disclosure, the diverter member 31 has a passing through chamber 317, and the second outlet opening 3113 and the second inlet opening 3121 respectively communicate with the passing through chamber 317.

Said gearing member 32 has a mad-section hinged to the diverter member 31, and positioned at the openings of the first installing groove 311 and the second installing groove 312. According to embodiments of the present disclosure, a first button 35 is fixed on the gearing member 32, in order to be operated conveniently.

Said first switching assembly 33 includes a first fixing member 331, a first linking rod 332 and a sealing member 333. The first fixing member 331 is correspondingly positioned to seal between the hole of the first installing groove 311 and the first inlet opening 3111, and to block the first outlet opening 3112. The first fixing member 331 has a first movable chamber 3311, and a hole of the first movable chamber 3311 faces the second outlet opening 3113. The first movable chamber 3311 has a fifth outlet opening 3312 communicating with the first outlet opening 3112. The first movable chamber 3311 has a first perforation 3313 positioned in the axial direction of the first installing groove 311. The first linking rod 332 movably fits to seal the first perforation 3313. One end of the first linking rod 332 is hinged to one end of the gearing member 32. A first return spring 36 is positioned between one end of the gearing member 32 and the first fixing member 331. The sealing member 333 has a second movable chamber 3331. The first linking rod 332 has a blocking flange 3321 positioned at another end of the first linking rod 332. A restrain member 334 is fixed at a hole of the second movable chamber 3331. The first linking rod 332 movably passes through the restrain member 334. The another end of the first linking rod 332 is movably corresponding to the second movable chamber 3331, and the blocking flange 3321 is movably corresponding to the restrain member 334. A second return spring 335 is positioned between the first movable chamber 3311 and the sealing member 333, and the sealing member 333 movably fits to seal the hole of the first movable chamber 3311 or the second outlet opening 3113. In order to increase the sealing property of products, a first sealing ring 336 is sleeved around said sealing member 333, and movably fits to seal the hole of the first movable chamber 3311 or the second outlet opening 3113; a second sealing ring 337 is sleeved around said first sealing rod 332, and movably fits to seal the hole of the first perforation 3313; a first sealing loop 338 is sleeved around said first fixing member 331, and movably fits to seal between the first fixing member 331 and the first installing groove 311. Further, the second movable chamber 3331 has a height greater than or equal to a gap between the first inlet opening 3111 and the second outlet opening 3113 in the axial direction of the first installing groove 311.

Said second switching assembly 34 includes a second fixing member 341 and a second linking rod 342. The second fixing member 341 is correspondingly positioned to seal between the hole of the second installing groove 312 and the second inlet opening 3121, and to block the third outlet opening 3122. The second fixing member 341 has a third movable chamber 3411, and a hole of the third movable chamber 3411 faces the fourth outlet opening 3123. The third movable chamber 3411 has a sixth outlet opening 3412 communicating with the third outlet opening 3122. The third movable chamber 3411 has a second perforation 3413 positioned in the axial direction of the second installing groove 312. One end of the second linking rod 342 movably fits to seal the second perforation 3413, and movably abuts against another end of the gearing member 32. The second linking rod 342 has a first sealing portion 3421 positioned at another end of the second linking rod 342 and movably fitting to seal a hole of the third movable chamber 3411 or the fourth outlet opening 3123. A third return spring 343 is positioned between the first sealing portion 3421 and the bottom of the second installing groove 312. According to embodiments of the present disclosure, a supporting member 3124 is positioned on said fourth outlet opening 3123, and the supporting member 3124 has a first fixing rod 3125 protruded from a mid-section of the supporting member 3124 toward the first sealing portion 3421. The first sealing portion 3421 has a second installing chamber 3422 corresponding to the first fixing rod 3125. The first fixing rod 3125 passes through the second installing chamber 3422, and the third return spring 343 is positioned between a bottom of the second installing chamber 3422 and a top of the first fixing rod 3125. A third sealing ring 344 is sleeved around said first sealing portion 3422, and movably fits to seal the hole of the third movable chamber 3411 or the fourth outlet opening 3123. A fourth sealing ring 345 is sleeved around a mid-section of said second linking rod 342, and movably fits to seal between the second perforation 3413 and the sixth outlet opening 3412. A second sealing loop 346 is sleeved around said second fixing member 341, and movably fits to seal between the second fixing member 341 and the second installing groove 312.

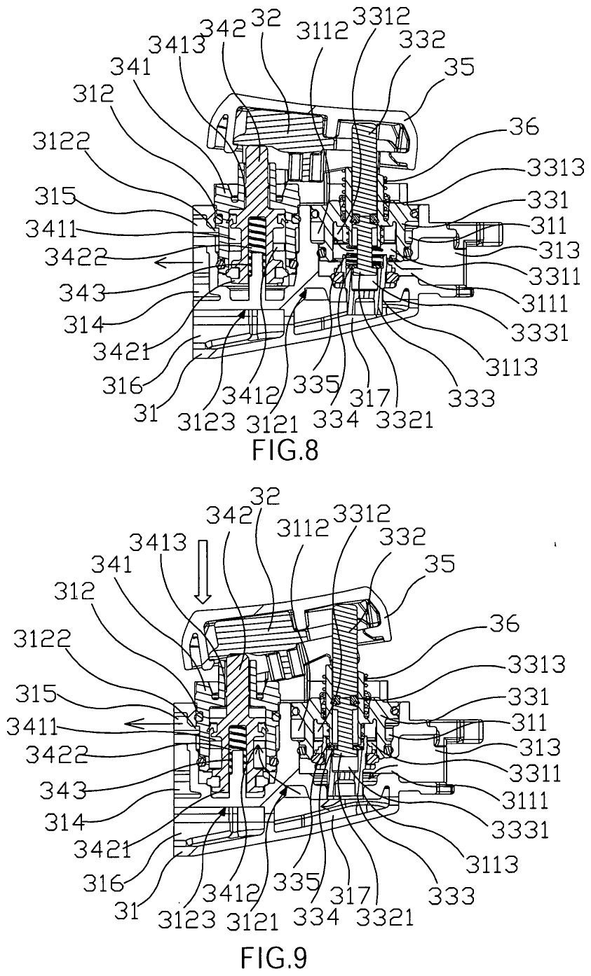

As shown in FIG. 8, when the switching assembly 3 is in an initiation state, the second return spring 335 abuts against the sealing member 333, whereby the sealing member 333 could fit to seal the second outlet opening 3113, and could open the first outlet opening 3112; the third return spring 343 abuts against the first sealing portion 3421, whereby the first sealing portion 3421 could fit to seal the hole of the third movable chamber 3411, and could open the fourth outlet opening 3123. At that time, water flows through the first inlet channel 313 into the diverter member 31, and flows through the first inlet opening 3111 into the first installing groove 311, and flows into the first movable chamber 3311, and sequentially flows through the fifth outlet opening 3312 and the first outlet opening 3112 into the first outlet channel 314, so as to outlet from the first outlet chamber 314. When the second outlet opening 3113 is blocked by the sealing member 333, water cannot flow into the second installing groove 312, whereby the second outlet channel 315 and the third outlet channel 316 cannot outlet water, so that a first outlet mode is provided. The first outlet mode is the initiation state.

As shown in FIG. 9, when one end of the first button 35 close to the second linking rod 342 is pressed manually, and one end of the gearing member 32 close to the second linking rod 342 is pressed, whereby to move toward the second linking rod 342. The second linking rod 342 is moved away from the hole of the third movable chamber 3411 and is moved toward the fourth outlet opening 3123 in the axial direction of the second installing groove 312, so that the first sealing portion 3421 correspondingly fits to seal the fourth outlet opening 3123. The another end of the gearing member 32 rotates back to the manual direction, for the gearing member 32 is hinged to the diverter member 31, so the gearing member 32 drives the first linking rod 332 to move away from the second outlet opening 3113 in the axial direction of the first installing groove 311. The blocking flange 3321 is moved in the second movable chamber 3331 and abuts against the restrain member 334, so as to drive the sealing member 333 to move and correspondingly seal the hole of the first movable chamber 3311, and to open the second outlet opening 3113. At the moment, water flows through the first inlet channel 313 into the diverter member 31, and sequentially flows through the first inlet opening 3111 into the first installing groove 311, and flows through the second outlet opening 3113 into the passing through chamber 317, and flows through the second inlet opening 3121 into the second installing groove 312, and flows into the third movable chamber 3411, and sequentially flows through the sixth outlet opening 3412 and the third outlet opening 3122 into the second outlet channel 315, whereby to outlet water from the second outlet channel 315. When the hole of the first movable chamber 3311 is blocked by the sealing member 333, and the fourth outlet opening 3123 is blocked by the sealing portion 3421, water cannot flow into the first outlet channel 314 and the third outlet channel 316, so that the first outlet mode is switched to a second outlet mode. In the second outlet mode, due to the water pressure, the sealing member 333 always fits to the hole of the first movable chamber 3311, in order to keep opening the second outlet opening 3113. The first sealing portion 3421 needs to be pressed manually and continuously in order to keep fitting the first sealing portion 3421 to the fourth outlet opening.

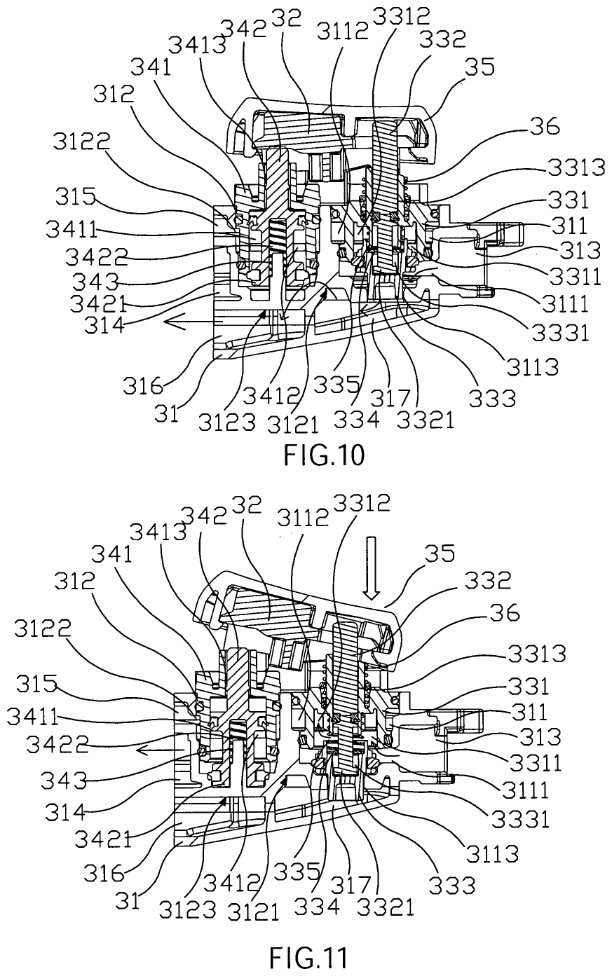

As shown in FIG. 10, when the one end of the first button 35 close the second linking rod 342 is no longer pressed, the third return spring 343 abuts against the first sealing portion 3421, so that the first sealing portion 3421 is returned to seal the hole of the third movable chamber 3411, and to open the fourth outlet opening 3123. In addition, the second linking rod 342 abuts against the gearing member 32 to return, and drives the first linking rod 332 to return, whereby the blocking flange 3321 is moved in the second movable chamber 3331, so that the sealing member 333 is returned nut not be pressed. For the cooperation of water pressure, the sealing member 333 keeps fitting to seal the opening of the first movable chamber 3311, and keeps the second outlet opening 3113 being opened. At the moment, water flows through the first inlet channel 313 into the diverter member 31, and sequentially flows through the first inlet opening 3111 into the first installing groove 311, and flows through the second outlet opening 3113 into the passing through chamber 317, and flows through the second inlet opening 3121 into the second installing groove 312, and flows through the fourth outlet opening 3123 into the third outlet channel 316, whereby to outlet water from the third outlet channel 316. When the hole of the first movable chamber 3311 is blocked by the sealing member 333, and the hole of the third movable chamber 3411 is blocked by the first sealing portion 3421, water cannot flow into the first outlet channel 314 and the second outlet channel 315, so that the second outlet mode is switched to a third outlet mode. Accordingly, by pressing and releasing the one end of the gearing member 32 close to the second linking rod 342, the second outlet mode and the third outlet mode could be switched.

As shown in FIG. 11, when it needs to switch to the first outlet mode, one end of the first button 35 close to the first linking rod 332 is pressed manually, and one end of the gearing member 32 close to the first linking rod 332 is pressed manually, whereby the first linking rod 332 is moved toward the second outlet opening 3113 in the axial direction of the first installing groove 311, so that the sealing member 333 is moved away from the hole of the first movable chamber 3311, and correspondingly fits to seal the second outlet opening 3113. At that time, water flows through the first inlet channel 313 into the diverter member 31, and flows through the first inlet opening 3111 into the first installing groove 311, and flows into the first movable chamber 3311, and sequentially flows through the fifth outlet opening 3312 and the first outlet opening 3112 into the first outlet channel 314, so as to outlet from the first outlet chamber 314. When the second outlet opening 3113 is blocked by the sealing member 333, water cannot flow into the second installing groove 312, whereby the second outlet channel 315 and the third outlet channel 316 cannot outlet water, so that the third outlet mode is switched to the first outlet mode. In addition, when no water flows into the switching assembly 3, the second return spring 335 could drive the sealing member 333 to return, and could correspondingly fit to seal the second outlet opening 3113, either.

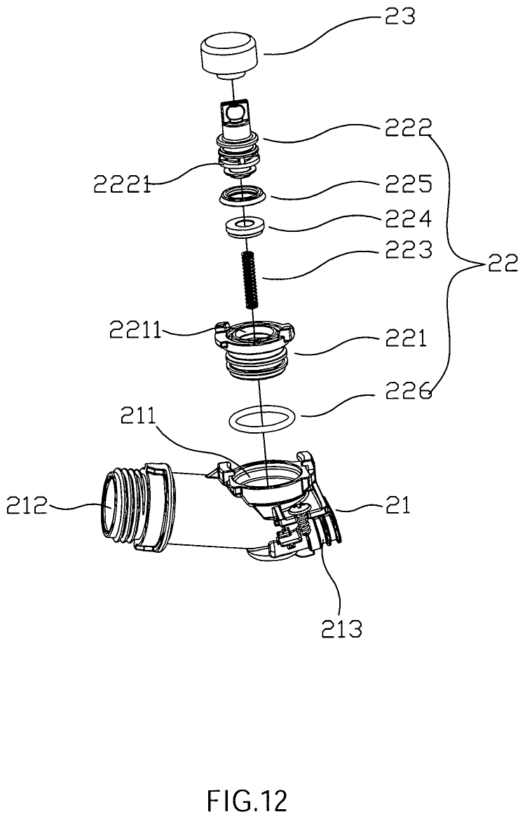

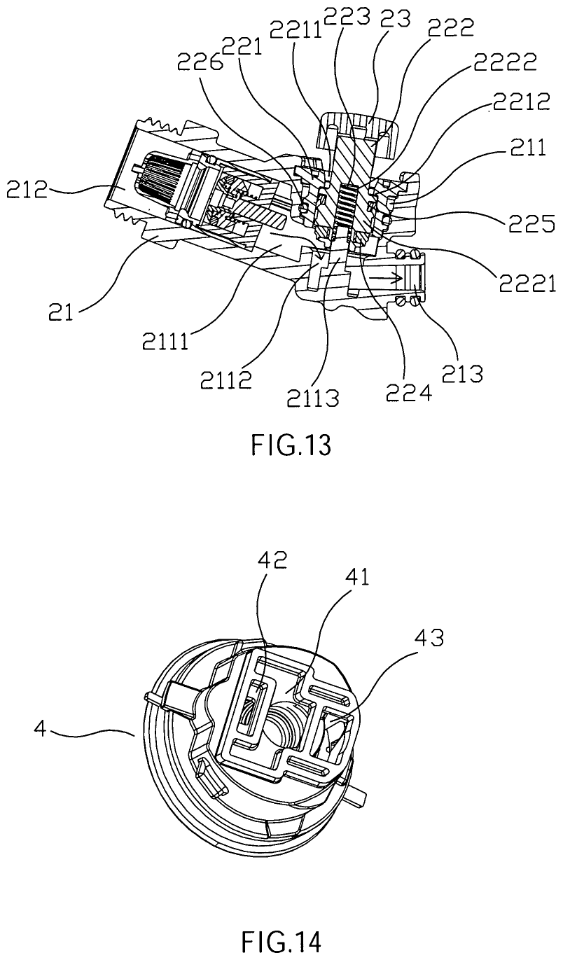

As shown in FIG. 12 and FIG. 13, said inlet assembly 2 includes an inlet member 21 and a third switching assembly 22. Said inlet member 21 has a third installing groove 211 recessed from a surface of the inlet member 21. The third switching assembly 22 correspondingly fits in the third installing groove 211. The inlet member 21 has a second inlet channel 212 at an inlet end of the inlet member 21, and a fourth outlet channel 213 at an outlet end of the inlet member 21. The second inlet channel 213 is adapted to connect to a pipe. The fourth outlet channel 213 communicates with the first inlet channel 313. Said third installing groove 211 has a third inlet opening 2111 and a seventh outlet opening 2112, wherein the seventh outlet opening 2112 is positioned at a bottom of the third installing groove 211. The third inlet opening 2111 communicates with the second inlet channel 212, and the seventh outlet opening 2112 communicates with the fourth outlet channel 213.

Said third switching assembly 22 includes a third fixing member 221 and a third linking rod 222. The third fixing rod 221 correspondingly fits to seal between a hole of the third installing groove 211 and the third inlet opening 2111. The third fixing member 221 has a third perforation 2211 positioned in an axial direction of the third installing groove 211. The third linking rod 222 movably fits to seal the third perforation 2211. One end of the third linking rod 222 passes through the inlet member 21 while the third linking rod 222 has a second sealing portion 2221 positioned at another end of the third linking rod 222. A fourth return spring 223 is positioned between the second sealing portion 2221 and the bottom of the third installing groove 211. A restrain flange 2212 is positioned at the third perforation 2211, and is corresponding to the second sealing portion 2221. The second sealing portion 2221 movably fits to seal the restrain flange 2212 or the seventh outlet opening 2112. According to embodiments of the present disclosure, said seventh outlet opening 2112 has a second fixing rod 2113 positioned at a bottom of the seventh outlet opening 2112. The second sealing portion 2221 has a third installing chamber 2222 corresponding to the second fixing rod 2113. The second fixing rod 2113 passes through the third installing chamber 2222, and a fourth return spring 223 is positioned between a bottom of the third installing chamber 2222 and a top of the second fixing rod 2113. According to embodiments of the present disclosure, a fifth sealing ring 224 is sleeved around said second sealing portion 2221, and movably fits to seal the seventh outlet opening 2112. According to embodiments of the present disclosure, a sixth sealing ring 225 is sleeved around a mid-section of said third linking rod 2211, and movably fits to seal between the third perforation 2211 and the third inlet opening 2111. According to embodiments of the present disclosure, a third sealing loop 226 is sleeved around said third fixing member 221, and movably fits to seal between the third fixing member 221 and the third installing groove 211. According to embodiments of the present disclosure, a second button 23 is connected to one end of said third linking rod 222. Through pressing the second button 23, the second sealing portion 2221 is moved away from the restrain flange 2212, and fits to seal the seventh outlet opening 2112, whereby to temporarily block water to inlet the switching assembly 3 by the inlet assembly 2, in order to prevent water from sprinkling on the ground or platform while users move the hand shower.

As shown in FIG. 14, said outlet assembly 4 includes a first outlet chamber 41, a second outlet chamber 42 and a third outlet chamber 43 respectively corresponding to the first outlet channel 314, the second outlet channel 315 and the third outlet channel 316. The first outlet channel 314 communicates with the first outlet chamber 41, the second outlet channel 315 communicates with the second outlet chamber 42, and the third outlet channel 316 communicates with the third outlet chamber 43. An outlet mode of the first outlet chamber 41, an outlet mode of the second outlet chamber 42 and an outlet mode of the third outlet chamber 43 are different from each other.

Through the mentioned structure, the first switching assembly 33 could control the two outlet openings of the first installing groove 311 while the second switching assembly 34 could control the two outlet openings of the second installing groove 312, and the gearing member 32 is positioned to drive the first switching assembly 33 and the second switching assembly 34 to be continuously operated with each other, whereby to switch three outlet modes in the present disclosure, so as to provide products having compact structure, so as to reduce a volume of the products, and to decrease the cost of production. Further, one end of the first linking rod 332 could be moved in the second movable chamber 3331 positioned in the sealing member 333, so that the second outlet opening 3113 could keep being opened during switching, whereby to continuously outlet from the second outlet opening 3113, in order to inlet into the second installing groove 312, and to outlet from the second outlet channel 315 and the third outlet channel 316.

In addition, for the third switching assembly 32 is positioned in the inlet assembly 2, the pause inlet function could be provided, which is convenient to move a hand shower in use, and could prevent water from sprinkling.

It must be pointed out that the embodiments described above are only some preferred embodiments of the present disclosure. All equivalent structures which employ the concepts disclosed in this specification and the appended claims should fall within the scope of the present disclosure.

What is claimed is:

1. A flow switch for a hand shower, comprising an inlet assembly, a switching assembly and an outlet assembly, the inlet assembly is installed at an inlet end of the switching assembly while the outlet assembly is installed at an outlet end of the switching assembly; characterized in that: the switching assembly comprises a diverter member, a gearing member, a first switching assembly and a second switching assembly; the diverter member has a first installing groove and a second installing groove recessed from a surface of the diverter member, an extended direction of the first installing groove is parallel to an extended direction of the second installing groove, and the opening of the first installing groove face the opening of the second installing groove; the first switching assembly correspondingly fits into the first installing groove, and the second switching assembly correspondingly fits into the second installing groove; said diverter member has a first inlet channel positioned at the inlet end of the diverter member, and has a first outlet channel, a second outlet channel and a third outlet channel positioned at the outlet end of the diverter member; said first installing groove has a first inlet opening communicating with the first inlet channel, and a first outlet opening and a second outlet opening communicating with the first outlet channel; the first outlet opening, the first inlet opening and the second outlet opening are sequentially arranged on an inner wall of the first installing groove in an axial direction of the first installing groove; the second outlet opening is positioned at a bottom of the first installing groove; said second installing groove has a second inlet opening communicating with the second outlet opening, a third outlet opening communicating with the second outlet channel and a fourth outlet opening communicating with the third outlet channel; the third outlet opening, the second inlet opening and the fourth outlet opening are sequentially arranged on an inner wall of the second installing groove in an axial direction of the second installing groove; the fourth outlet opening is positioned at a bottom of the second installing groove; said gearing member has a mad-section hinged to the diverter member and positioned at the openings of the first installing groove and the second installing groove;
said first switching assembly comprises a first fixing member, a first linking rod and a sealing member; the first fixing member is correspondingly positioned to seal between the hole of the first installing groove and the first inlet opening, and to block the first outlet opening; the first fixing member has a first movable chamber, and a hole of the first movable chamber faces the second outlet opening; the first movable chamber has a fifth outlet opening communicating with the first outlet opening; the first movable chamber has a first perforation positioned in the axial direction of the first installing groove; the first linking rod movably fits to seal the first perforation; one end of the first linking rod is hinged to one end of the gearing member; a first return spring is positioned between one end of the gearing member and the first fixing member; the sealing member has a second movable chamber; the first linking rod has a blocking flange positioned at another end of the first linking rod; a restrain member is fixed at a hole of the second movable chamber;
the first linking rod movably passes through the restrain member; the another end of the first linking rod is movably corresponding to the second movable chamber, and the blocking flange is movably corresponding to the restrain member; a second return spring is positioned between the first movable chamber and the sealing member, and the sealing member movably fits to seal the hole of the first movable chamber or the second outlet opening; said second movable chamber has a height greater than or equal to a gap between the first inlet opening and the second outlet opening in the axial direction of the first installing groove;
said second switching assembly comprises a second fixing member and a second linking rod; the second fixing member is correspondingly positioned to seal between the hole of the second installing groove and the second inlet opening, and to block the third outlet opening; the second fixing member has a third movable chamber, and a hole of the third movable chamber faces the fourth outlet opening; the third movable chamber has a sixth outlet opening communicating with the third outlet opening; the third movable chamber has a second perforation positioned in the axial direction of the second installing groove; the second linking rod has a first sealing portion positioned at another end of the second linking rod and movably fitting to seal a hole of the third movable chamber or the fourth outlet opening; a third return spring is positioned between the first sealing portion and the bottom of the second installing groove; said second movable chamber in the first installing groove has a height greater than or equal to a gap between the second inlet opening and the fourth outlet opening in the axial direction of the second installing groove.

2. The flow switch for a hand shower of claim 1, wherein said inlet assembly comprises an inlet member and a third switching assembly; said inlet member has a third installing groove recessed from a surface of the inlet member, the third switching assembly correspondingly fits in the third installing groove; the inlet member has a second inlet channel at an inlet end of the inlet member, and the second inlet channel is adapted to connect to a pipe; the inlet member has a fourth outlet channel at an outlet end of the inlet member, and the fourth outlet channel communicates with the first inlet channel; said third installing groove has a third inlet opening communicating with the second inlet channel, and a seventh outlet opening communicating with the fourth outlet channel; the seventh outlet opening is positioned at a bottom of the third installing groove; said third switching assembly movably fits to seal the seventh outlet opening.

3. The flow switch for a hand shower of claim 2, wherein said third switching assembly comprises a third fixing member and a third linking rod; the third fixing rod correspondingly fits to seal between a hole of the third installing groove and the third inlet opening; the third fixing member has a third perforation positioned in an axial direction of the third installing groove; the third linking rod movably fits to seal the third perforation; one end of the third linking rod passes through the inlet member while the third linking rod has a second sealing portion positioned at another end of the third linking rod; a fourth return spring is positioned between the second sealing portion and the bottom of the third installing groove; a restrain flange is positioned at the third perforation, and is corresponding to the second sealing portion; the second sealing portion movably fits to seal the restrain flange or the seventh outlet opening.

4. The flow switch for a hand shower of claim 3, wherein said seventh outlet opening has a second fixing rod positioned at a bottom of the seventh outlet opening, the second sealing portion has a third installing chamber corresponding to the second fixing rod; the second fixing rod passes through the third installing chamber, and a fourth return spring is positioned between a bottom of the third installing chamber and a top of the second fixing rod.

5. The flow switch for a hand shower of claim 3, wherein a third sealing ring is sleeved around said third fixing member, the third sealing ring correspondingly fits to seal between the third fixing member and the third installing groove.

6. The flow switch for a hand shower of claim 1, wherein said outlet assembly comprises a first outlet chamber, a second outlet chamber and a third outlet chamber respectively corresponding to the first outlet channel, the second outlet channel and the third outlet channel; the first outlet channel communicates with the first outlet chamber, the second outlet channel communicates with the second outlet chamber, the third outlet channel communicates with the third outlet chamber; an outlet mode of the first outlet chamber, an outlet mode of the second outlet chamber and an outlet mode of the third outlet chamber are different from each other.

7. The flow switch for a hand shower of claim 1, further comprising a housing of the hand shower, the housing of the hand shower comprises a first installing chamber, and the inlet assembly, the switching assembly and the outlet assembly are sequentially connected to each other and are installed in the first installing chamber.

8. The flow switch for a hand shower of claim 1, wherein said diverter member has a passing through chamber, and the second outlet opening and the second inlet opening respectively communicate with the passing through chamber.

9. The flow switch for a hand shower of claim 1, wherein a first button is fixed on said gearing member, in order to be operated conveniently.
